(19) United States
(12) Patent Application Publication
(10) Pub. No.: US 2001/0054006 A1
(43) Pub. Date: Dec. 20, 2001

(54) Points trading service method and system therefor

(76) Inventors: Kee-hwan Lee, Seoul (KR); Sun-jung Kim, Seoul (KR); Gwi-ho Lee, Seoul (KR); Hye-ju Kim, Metropolitan-city (KR)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/751,391

(22) Filed: Jan. 2, 2001

(30) Foreign Application Priority Data
Jun. 19, 2000 (KR) 00-33579

(51) Int. Cl. G06F 17/60

(52) U.S. Cl. 705/26; 705/37; 705/39

(57) ABSTRACT

A points trading service method is provided and includes the steps of (a) collecting information on a customers' trading points total from a member shop and storing the information in a customer database; (b) receiving information on a points trade request from a customer; and (c) trading points with other customers according to the points trade request. According to the method of the present invention, a customer can redeem a small amount of points into cash and exchange the points the user does not want to use for other points. Upon collecting trading points, a customer can also use the cyber money or points at a plurality of member shops. Therefore, when the method according to the present invention is applied, Internet business marketing and cyber money use can be extended and promoted.

### BACKGROUND OF THE INVENTION

1. Field of the Invention

The present invention relates to a points trading service method and a system therefor and, more particularly, to a points trading service method whereby points can be sold and bought or exchanged for other member shops' points, and a system therefor.

2. Description of the Related Art

Currently, many shopping mall sites or credit card companies offer point accumulation systems as additional services. According to a point management method based on a point accumulation system, when a customer uses services or buys products, a member shop gives the customer points based on the amount of time the customer uses such services or based on the value of purchased items, and points are thus accumulated.

FIG. 1 illustrates an existing point management method. Referring to FIG. 1, in the existing cyber-money management service method, when a user buys products in a member shop, or the user clicks on an advertisement provided by a member shop, points are accrued, and then the information of the accrued points is input to a server of the corresponding site. When the accumulated points become greater than a predetermined level, the user can buy predetermined products in the cyber space, using the accumulated points.

However, according to the existing cyber-money management service method, the user of cyber-money faces inconvenient limitations on the use of the points, even though Internet cyber-money is a new-concept currency in a closed market of specific sites or networks. That is, according to the existing cyber-money management service method, the user of cyber-money can use the points only when the accumulated points become equal to or greater than a predetermined level. For example, only when the accumulated points are equal to or greater than 50,000 points, the user is paid 50 dollars of cash, or the user can only use the points accumulated when the points total is equal to or more than 10,000 points.

According to another existing cyber-money management service method, member shops which apply the method exist so that points are accumulated by purchasing various products through various purchasing routes and the points can therefore be used in the various purchasing routes.

However, this cyber-money management service method still has a problem in that unless the accumulated points are equal to or greater than a predetermined level, customers cannot actually benefits from the points.

### SUMMARY OF THE INVENTION

To solve the above problems, it is an object of the present invention to provide a points trading service method in which cyber-money is exchanged or sold and bought.

It is another object of the present invention to provide a points trading service apparatus for carrying out the points trading service method.

It is another object of the present invention to provide a points trading service system for carrying out the points trading service method.

To accomplish the above object of the present invention, there is provided a points trading service method, the method including the step of (a) receiving through a telecommunications network a request for trading the points a customer gets from a member shop, and carrying out the transaction corresponding to the request for trading points with other customers.

To accomplish the other objects of the present invention, there is also provided a points trading service method wherein the method includes the steps of (a) collecting information on customers' points from member shops and storing the information in a customer database; (b) receiving information on a points trade request from a customer; and (c) trading points with other customers according to the received information on the points trade request.

It is preferable that the points are selected from cyber money, product purchasing points, advertisement clicking points, thank-you coupon, and mileage points.

It is preferable that the method further includes the step of (d) updating a customer database and a transaction database according to the result of processing the points transaction, and sending the result to the corresponding member shop.

It is preferable that the method further includes the step of (e) carrying out settlement of points when the customer purchases goods with the points.

To accomplish the further object of the present invention, there is also provided a points trading service method, wherein the method includes the steps of (a) collecting information on customers' points from member shops and storing the information in a customer database; (b) sending information on the customers' points and exchange rates stored in the customer database; (c) receiving a points trade request from the customer; and (d) transacting customer's points according to received trade request.

To accomplish the still further object of the present invention, there is also provided a points trade service method, the method including the steps of (a) receiving a request for buying points from a customer; (b) buying points corresponding to the buying request; and (c) updating a customer database according to the result of buying processing, and sending the result to the member shop corresponding to the points.

To accomplish yet a further object of the present invention, there is also provided a points trading service apparatus for providing a points trading service through a telecommunications network wherein the apparatus includes; an information collecting unit for collecting information about customers' points from member shops; a customer database for storing the information on customers' points received from member shops; a transaction processing unit for receiving information on a points trade request from a customer and processing point transaction with other customers according to the received information on the points trade request; and a transaction database for storing information on a points trade request sent from customers and the result of processing transactions.

It is preferable that the apparatus further includes an information providing unit for sending customer's point information and transaction exchange information stored in the customer database.

It is preferable that the exchange rate information indicates cash value or absolute value corresponding to points and is provided by a separate system installed outside the service providing server.

It is preferable that the apparatus further includes a shopping mall management unit for processing cyber shopping, and providing points in proportion to goods and services purchased and for buying goods using the points.

It is preferable that the apparatus further includes a network interface for linking a member shop server, a web server and a customer computer based on the worldwide web.

To accomplish yet another object of the present invention, there is also provided a points trading service system in which a points trading service is provided through a telecommunications network wherein the point trade service system includes; a telecommunications network; a customer computer for sending information on a points trade request; a member shop computer for providing customers' points through the telecommunications network; and a service providing server for storing the customers' points received from the member shop computer, receiving information on the points trade request from the customer, and processing points transactions with other customers according to the received trade request information.

### BRIEF DESCRIPTION OF THE DRAWINGS

The above objects and advantages of the present invention will become more apparent by describing in detail a preferred embodiment thereof with reference to the attached drawings, in which:

FIG. 1 illustrates the existing points management method;

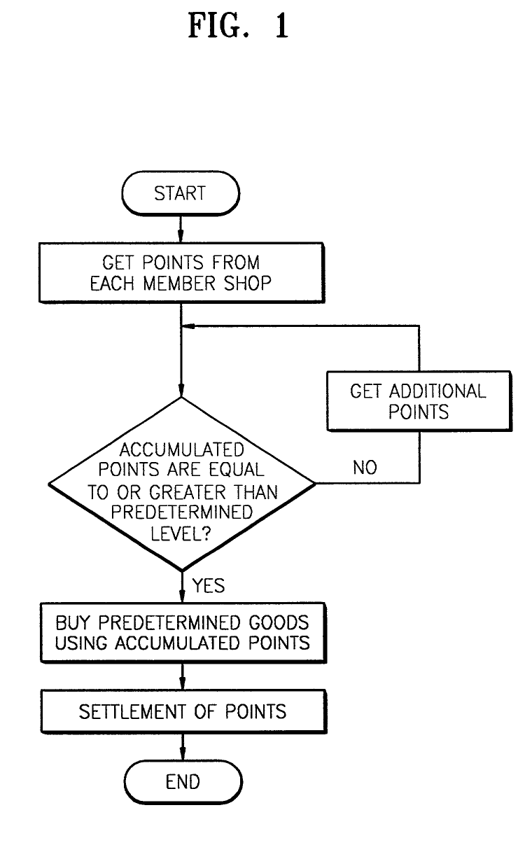

FIG. 2 is a block diagram showing a points trading service system according to an embodiment of the present invention;

FIG. 3 is a flowchart showing major steps of a points trading service method according to an embodiment of the present invention;

FIG. 4 illustrates an example of a screen displaying a web document, including details of customer's holding points and information on selection of trade requests, sent from a service providing server; and

FIG. 5 illustrates an example of a screen displaying a web document having the processed results of point sales requests sent from a service providing server.

### DETAILED DESCRIPTION OF THE INVENTION

Hereinafter, embodiments of the present invention will be described in detail with reference to the attached drawings. The present invention is not restricted to the following embodiments, and many variations are possible within the spirit and scope of the present invention. The embodiments of the present invention are provided in order to more completely explain the present invention to one skilled in the art.

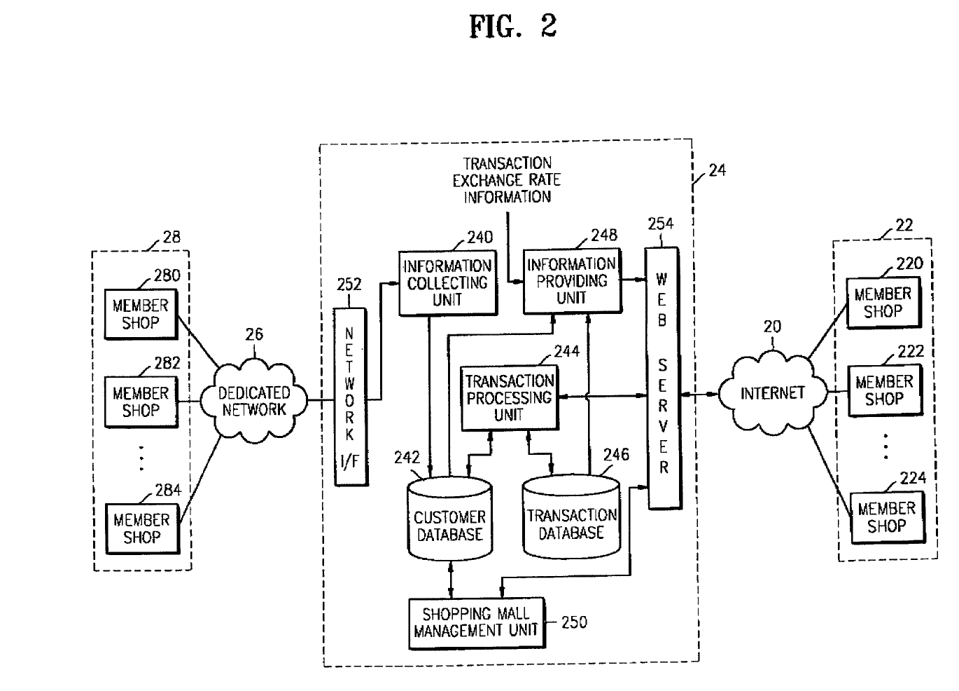

FIG. 2 is a block diagram showing a points trading service system according to an embodiment of the present invention.

The points trading service system according an embodiment of the present invention uses the Internet 20 and includes a plurality of customer computers 22 (220, 222, 224), which are connected to the Internet, a service providing server 24, and member shop server 28 including a plurality of member shop computers 280, 282 and 284, which are connected to the service providing server.

The service providing server 24 includes an information collecting unit 240 for collecting customers' points information from the member shops; a customer database 242 for storing customers' points information received from the member shops; a transaction processing unit 244 for processing point transactions with other customers after receiving a points trade request from a customer; a transaction database 246 for storing points trade request information received from customers and the results of the transaction processing; an information providing unit 248 for sending customers' point information and trade exchange rate information stored in the customer database to the customers; a shopping mall management unit 250 for processing cyber-shopping, providing points according to the purchase value, and providing a service for buying goods using the points; and a network interface 252 for linking the member shop server 28, the web server 254 and customer computers 22 on the worldwide web.

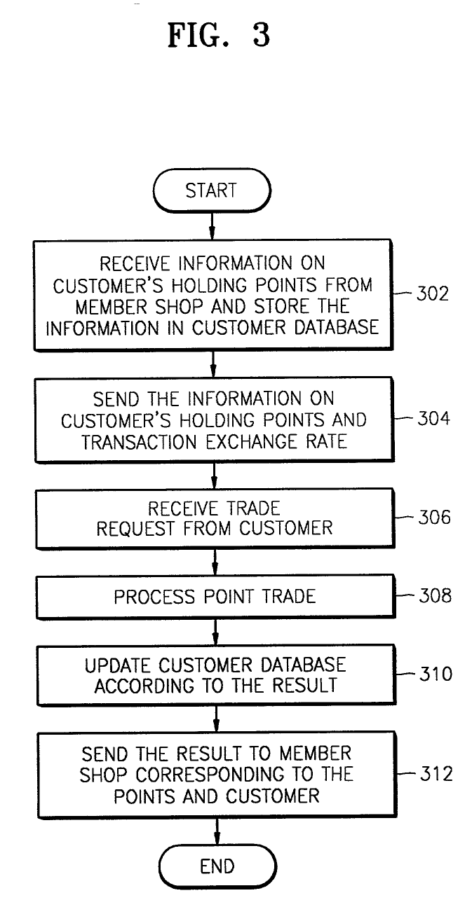

In the system of FIG. 2, the points trading service method according to a preferred embodiment of the present invention, as shown in FIG. 3, is carried out. Referring to FIG. 2, first, the information collecting unit 240 receives information on the customer's total points from a member shop through a dedicated network 26, connected to the member shop server 28 and the network interface 252 for linking the member shop server 28, and stores it in the customer database 242, in step 302. Preferably, the dedicated network is based on a wide area network (WAN), but when security is guaranteed, the network can be based on the Internet. Generally, the number of member shops is great and therefore, it is preferable that the service providing server requests member shops to periodically send customers' total points information. Alternatively, member shops can send information on total points of customers to the service providing server.

Meanwhile, a user linked to the site inputs their user ID and password. Using the user ID and password, the customer database 242 is accessed and it is checked whether or not the linked user is an authenticated user. When the check indicates that the user is authenticated, the information providing unit 248 of the service providing server 24 sends information on the customer's total points and trade exchange rate information to the customer in step 304.

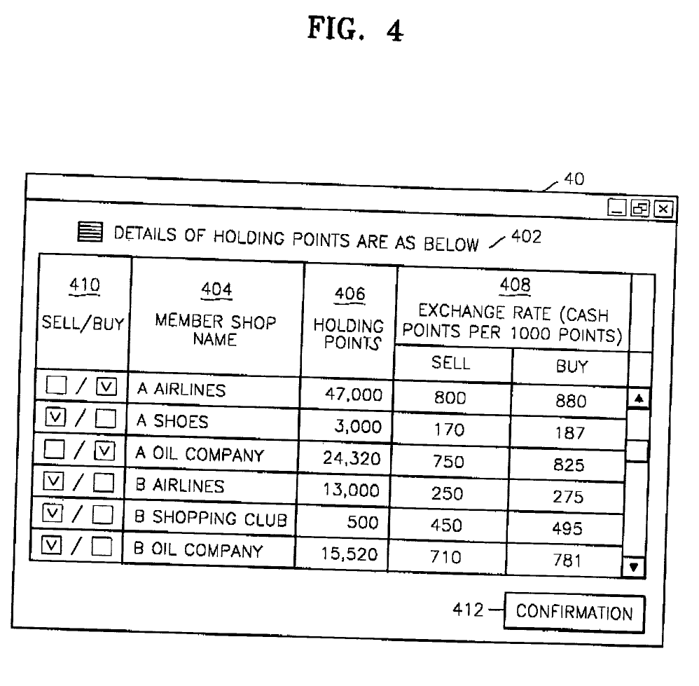

For example, the information providing unit 248 of the service providing server 24 sends a web document including information on the customer's total points and information on the trade request selection. FIG. 4 illustrates an example of a screen displaying a web document, including information on the customer's total points and information on the selection of a trade request sent from the service providing server. Referring to FIG. 4, the screen 40 includes: a guide message 402, for example, “Details of holding points are as below,” a space for showing a member shop name 404, a space for showing holding points 406, and a space for showing a trade exchange rate 408. Referring to FIG. 4, the member shops where the customer points are held are A airlines, A shoes, A oil company, B airlines, B shopping club, and B oil company, and the points held are 47,000 points, 3,000 points, 24,320 points, 13,000 points, 500 points and 15,520 points, respectively. Also, the trade exchange rate is divided into a selling exchange rate and a buying exchange rate. The selling exchange rate is a cash point which the customer gets when selling points of a member shop. In the present embodiment, the buying exchange rate is a cash point required for buying a point, and the rate is fixed to 110% of the selling exchange rate in the present embodiment. The difference between the selling exchange rate and the buying exchange rate can be used for maintenance and management expenses and profits. The cash point is made by numerically expressing the amount of absolute value equivalent to cash, and the cash points can be fixed by determining it periodically or it can change according to the market principle. When the cash points change according to the market principle, it is preferable that it is provided by a separate system (not shown in the drawings) installed outside the service providing server. Referring to FIG. 4, the selling exchange rates of member shop points of A airlines, A shoes, A oil company, B airlines, B shopping club and B oil company, are 800 cash points, 170 cash points, 750 cash points, 250 cash points, 450 cash points, and 710 cash points, respectively, per 1000 points, while the buying exchange rates are 880 cash points, 187 cash points, 825 cash points, 275 cash points, 495 cash points, and 781 cash points, respectively, per 1000 points.

Also, the screen 40 includes a trade request space 410 where a selection can be made to buy or sell points. Therefore, by alternatively clicking between the selling selection space and the buying selection space, the customer can select to sell holding points or buy additional points. Referring to FIG. 4, the user wants to buy member shop points of A airlines and A oil company and sell member shop points of A shoes, B airlines, B shopping club, and B oil company.

When the user clicks a confirmation button 412, trade request information from the user is sent to the transaction processing unit 244 through the Internet and the web server 254 of the service providing server 24 in step 306. The transaction processing unit 244 stores the trade request information in the transaction database 246 and performs trading of points according to the received trade request information in step 308.

Among the registered trade request information, the transaction of points the user wants to sell is carried out when another customer wants to buy the points. That is, when another customer requests to buy the points, the transaction processing unit 244 receives the request for buying the points from the customer through the web server 254, checks whether or not points for sale corresponding to the buying request exist in the transaction database 246 and when it is checked that points for sale satisfying the buying request exist, the transaction is processed. Next, the transaction processing unit 244 updates the customer database 242 and the transaction database 246 according to the result of the transaction processing, and sends the results of buying request processing to the member shop of the points.

As described above, when a transaction is processed, the customer database 242 and the transaction database 246 are updated according to the result of the processing in step 310, and the result of the buying request processing is sent to the member shop of the points in step 312.

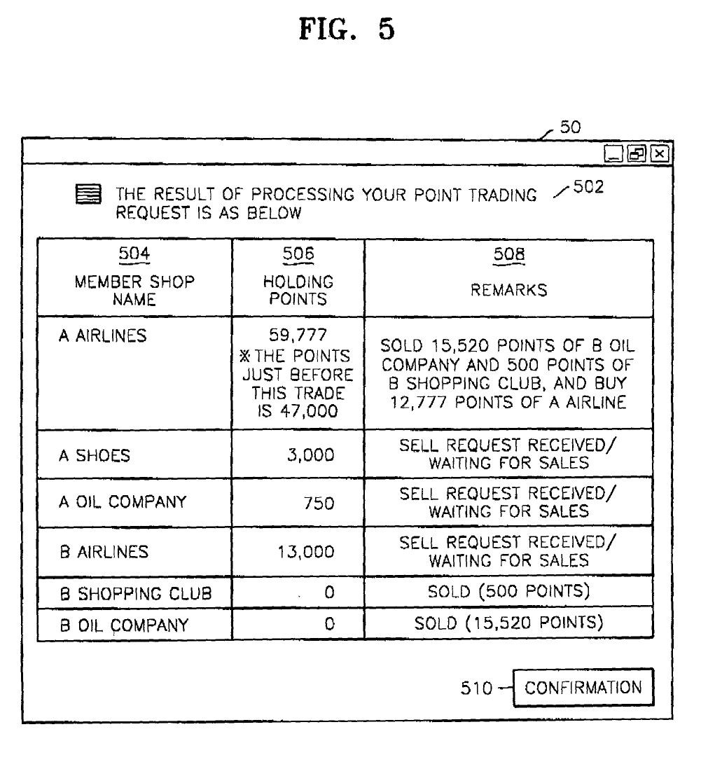

For example, the information providing unit 248 of the service providing server 24 sends a web document including the result of processing the received request for trading of points. FIG. 5 illustrates an example of a screen displaying a web document having the processed results of the point sales request from a customer. Referring to FIG. 5, the screen shows: a guide sentence 502 saying “The result of processing your point trading request is as below,” a space for showing a member shop name 504, a space for showing holding points 506, and a space for remarks 508. In the space for showing a member shop name 504, the names of member shops of which points the customers has are shown, in the space for showing holding points 506, the holding points of the member shops are shown, and in the space for remarks 508, the result or current state of processing a points trade request is shown. According to the space for remarks, among the points of A shoes, B airlines, B shopping club, and B oil company which the customer requested to sell, the points of A shoes, A oil company and B Airlines are waiting for a trade, while the points of B oil company and B shopping club have been sold. Therefore, by getting 225 cash points as a result of selling 500 points of B shopping club, 11,019 cash points as a result of selling 15,520 points of B oil company, the customer gets 11,244 cash points in total. Accordingly, the points of B shopping club and B oil company are marked as 0 points.

Also, in the present embodiment, cash points obtained by the sales are used for buying. For example, among the points of A airlines and A oil company the customer requests to buy, the points of A airlines are bought. The buying exchange rate of A airlines is 880 cash points per 1,000 points. When 11,244 cash points obtained through selling holding points are all used to buy 12,777 points of A airlines, the current points of A airlines becomes, as shown in FIG. 5, 59,777 points (the currently held 47,000 points+additionally bought 12,777 points). Now, the customer selects the confirmation button, and then the screen disappears.

The shopping mall management unit 250 manages a shopping mall on a web for providing its own cyber shopping, and provides points proportional to the customer's purchase amount and shopping service using the points.

According to the points trade service method, the points of each member shop the customer has can be bought and sold. Therefore, the customer can buy required points and sell surplus points. A site administrator gets a predetermined commission on the customer's trade so that the money can be used for required expenses or profits. Also, a service provider who manages the points trade service method according to the present invention periodically provides transaction data to credit card companies and banks so that the service providers can be paid management fees according to a separate contract.

In the above description, an example in which points are sold and other points are bought is explained. However, according to the present invention, the embodiment can be designed differently so that actual goods and cash exchanges are also available. Therefore, according to the present invention, when a customer wants to buy goods using accumulated points, the customer can use points, electronic money, in a number of member shops having contracted in advance, unlike the existing points management method in which a customer selects goods that the customer does not need practically. Also, a small number of points can be used to buy goods.

Also, in addition to the existing membership cards, a customer can buy goods in member shops, using a mobile phone having functions for Internet communications. That is, the customer is linked to a portal site based on the points trade service method according to the present invention, using a mobile phone through the Internet, and by inputting the user ID and password, the customer is authenticated. Next, the customer's proper bar code sent from the corresponding site is displayed on the LCD screen of the mobile phone. Using a bar code reader, the member shop reads the customer's proper bar code and asks for settlement of points. By doing so, buying goods with the points is enabled.

Also, the points trade service method according to the present invention can be written as a program operating in a personal computer or server-level computer. The program codes and code segments forming the program can be easily implemented by computer programmers in the field the present invention belongs to. Also the program can be stored in a computer readable recording medium. The recording medium includes magnetic recording media, optical recording media and radio media.

Though points are used as an example in the above embodiment, transactions for cyber money, thank-you coupons, and mileage points can be carried out in the same manner as in the above embodiment. That is, the present invention is not restricted to the above-described embodiments, and many variations are possible within the spirit and scope of the present invention. Therefore, the scope of the present invention is not determined by the description but by the accompanying claims.

As described above, according to the present invention, a user can exchange the points that the user will not use for points the user wants. Also, according to the present invention, a customer can use cyber money or points of a plurality of member shops that a customer has, after collecting them. Therefore, when the method according to the present invention is applied, Internet business marketing and cyber money use can be extended and promoted.

What is claimed is:

1. A points trading service method, the method comprising the step of:
receiving through a telecommunications network a request for trading points a customer gets from a member shop, and carrying out a transaction corresponding to the request for trading points with at least one other customer.

2. The method of claim 1, wherein the trading points are selected from the group consisting of: cyber money, product purchasing points, advertisement clicking points, thank-you coupon, and mileage points.

3. The method of claim 1, further comprising the step of:
calculating a balance of the customer's remaining trading points after the customer uses the trading points to purchase a good or a service.

4. A points trading service method, the method comprising the steps of:
(a) collecting information regarding a customers' trading points portfolio from member shops and storing the information in a customer database;
(b) receiving information on a points trade request from a customer; and
(c) initiating a trading points transaction with at least one other customer according to the received points trade request.

5. The method of claim 4, wherein the trading points are selected from the group consisting of: cyber money, product purchasing points, advertisement clicking points, thank-you coupon, and mileage points.

6. The method of claim 4, further comprising the step of:
updating a customer database and a transaction database according to a result from the trading points transaction, and sending the result to the corresponding member shop.

7. The method of claim 5, further comprising the step of:
updating a customer database and a transaction database according to a result from the trading points transaction, and sending the result to the corresponding member shop.

8. The method of claim 4, further comprising the step of:
calculating a balance of the customer's remaining trading points after the customer uses the trading points to purchase a good or a service.

9. The method of claim 5, further comprising the step of:
calculating a balance of the customer's remaining trading points after the customer uses the trading points to purchase a good or a service.

10. A points trading service method, the method comprising the steps of:
collecting information regarding a customers' trading points portfolio from member shops and storing the information in a customer database
sending information on the customer's trading points and exchange rates stored in the customer database;
receiving a points trade request from the customer; and
transacting customer's points according to the received trade request.

11. The method of claim 10, wherein the trading points are selected from the group consisting of: cyber money, product purchasing points, advertisement clicking points, thank-you coupon, and mileage points.

12. The method of claim 10, wherein the customer's trade request is for changing the customer's trading points into a cash equivalent and processing the customer's trading points according to the resulting cash equivalent.

13. The method of claim 11, wherein the customer's trade request is for changing the customer's trading points into a cash equivalent and processing the customer's trading points according to the resulting cash equivalent.

14. The method of claim 10, further comprising the step of:
updating a customer database and a transaction database according to the result of the customer's trade request, and sending the result to the corresponding member shop.

15. The method of claim 11, further comprising the step of:
updating a customer database and a transaction database according to the result of the customer's trade request, and sending the result to the corresponding member shop.

16. The method of claim 10, further comprising the step of:
calculating a balance of the customer's remaining trading points after the customer uses the trading points to purchase a good or a service.

17. The method of claim 11, further comprising the step of:
calculating a balance of the customer's remaining trading points after the customer uses the trading points to purchase a good or a service.

18. A points trade service method, the method comprising the steps of:
receiving a request to buy trading points from a customer;
buying trading points corresponding to the request; and
updating a customer database according to a result from the buying process, and sending the result to a member shop that corresponds to the trading points.

19. The method of claim 18, further comprising the step of:
sending information concerning the customer's trading points and transaction exchange rates stored in the customer database to the customer.

20. The method claim 18, wherein the trading points are selected from the group consisting of: cyber money, product purchasing points, advertisement clicking points, thank-you coupon, and mileage points.

21. The method of claim 19, wherein the trading points are selected from the group consisting of: cyber money, product purchasing points, advertisement clicking points, thank-you coupon, and mileage points.

22. The method of claim 18, further comprising the step of:
updating a customer database according to a result from the buying process, and sending the result to the member shop corresponding to the trading points.

23. The method of claim 19, further comprising the step of:
updating a customer database according to a result from the buying process, and sending the result to the member shop corresponding to the trading points.

24. The method of claim 18, further comprising the step of:
calculating a balance of the customer's remaining trading points after the customer uses the trading points to purchase a good or a service.

25. The method of claim 19, further comprising the step of:
calculating a balance of the customer's remaining trading points after the customer uses the trading points to purchase a good or a service.

26. The method of claim 22, further comprising the step of:
calculating a balance of the customer's remaining trading points after the customer uses the trading points to purchase a good or a service.

27. The method of claim 23, further comprising the step of:
calculating a balance of the customer's remaining trading points after the customer uses the trading points to purchase a good or a service.

28. A points trading service apparatus for providing a points trading service through a telecommunications network, the apparatus comprising:
an information collecting unit for collecting information on a customers' trading points from a plurality of member shops;
a customer database for storing the information on the customers' trading points received from the member shops;
a transaction processing unit for receiving information on a points trade request from a customer, and processing a trading point transaction with at least one other customer according points trade request; and
a transaction database for storing information on the points trade request sent from the customer and a result of processing transactions.

29. The apparatus of claim 28, further comprising:
an information providing unit for sending customer's trading point information and transaction exchange information stored in the customer database to the customer.

30. The apparatus of claim 29, wherein the trading points are selected from the group consisting of: cyber money, product purchasing points, advertisement clicking points, thank-you coupon, and mileage points.

31. The apparatus of claim 29, wherein the exchange rate information indicates a cash value or an absolute value corresponding to the trading points and is provided by a separate system installed outside of the service providing server.

32. The apparatus of claim 28, further comprising:
a shopping mall management unit for processing cyber shopping, and providing trading points in proportion to a good purchased and a service for buying goods with the trading points.

33. The apparatus of claim 29, further comprising:
a shopping mall management unit for processing cyber shopping, and providing trading points in proportion to a good purchased and a service for buying goods with the trading points.

34. The apparatus of claim 30, further comprising:
a shopping mall management unit for processing cyber shopping, and providing trading points in proportion to a good purchased and a service for buying goods with the trading points.

35. The apparatus of claim 31, further comprising:
a shopping mall management unit for processing cyber shopping, and providing trading points in proportion to a good purchased and a service for buying goods with the trading points.

36. The apparatus of claim 29, further comprising:
a network interface for linking a service provider server to a member shop server; and
a web server for linking a customer computer server to the service provider server via an internet.

37. The apparatus of claim 30, further comprising:
a network interface for linking a service provider server to a member shop server; and
a web server for linking a customer computer server to the service provider server via an internet.

38. The apparatus of claim 31, further comprising:
a network interface for linking a service provider server to a member shop server; and
a web server for linking a customer computer server to the service provider server via an internet.

39. A points trading service system wherein a points trading service is provided through a telecommunications network, the points trading service system comprising:
a telecommunications network;
a customer computer for sending information on a points trade request;
a member shop computer for providing customer's points through the telecommunications network; and
a service providing server for storing the customer's points received from the member shop computer, receiving information on the point trade request from the customer, and processing point transactions with other customers according to the received trade request information.

40. A computer program product for enabling a computer to execute a points trading transaction, comprising:
software instructions for enabling the computer to perform predetermined operations, and a computer readable medium bearing the software instructions;
said predetermined operations including the steps of:
collecting information on a customer's trading points from a member shop;
storing at the computer a record of the collected information for each customer;
receiving information on a points trade request from a customer's computer;
executing a trading transaction upon receiving the customer's trade request by trading points with at least one other customer;
calculating the customer's trading point balance once the transaction has been processed; and
sending the customer's final trading point balance to a customer database and the appropriate member shop.

41. The computer program product for enabling a computer to execute a points trading transaction according to claim 40, wherein the trading points are selected from the group consisting of: cyber money, product purchasing points, advertisement clicking points, thank-you coupon, and mileage points.

42. The computer program product for enabling a computer to execute a points trading transaction according to claim 40, wherein the customer trade request is for changing the customer's trading points into a cash equivalent and processing the customer's trading points according to the resulting cash equivalent.
